(19) United States
(12) Patent Application Publication
(10) Pub. No.: US 2025/0291347 A1
(43) Pub. Date: Sep. 18, 2025

(54) MANUAL OVERRIDE ACTUATOR FOR AUTOMATED DISTANCE CONTROL

(71) Applicant: Deere & Company, Moline, IL (US)

(72) Inventors: Riley J. Wegmann, Urbana, IA (US); William J. Vande Haar, Janesville, IA (US)

(21) Appl. No.: 18/605,108

(22) Filed: Mar. 14, 2024

(51) Int. Cl. G05D 1/227; A01D 41/02; G05D 1/223; G05D 1/224; G05D 105/15

(52) U.S. Cl. CPC G05D 1/227; A01D 41/02; G05D 1/2232; G05D 1/224; G05D 2105/15

(57) ABSTRACT

An automated ground distance control system automatically controls a propulsion vehicle to travel a desired distance. Operator actuation of a manual override actuator is detected. Based on the detected actuation, the automated ground distance control system controls the propulsion vehicle to move a manual override distance. In one example, a configuration system exposes an operator interface for configuring the value of the manual override distance.

### FIELD OF THE DESCRIPTION

The present description relates to controlling material transfer vehicles that unload material into containers, such as other vehicles. More specifically, the present description relates to manually overriding automated distance control of a material transfer vehicle.

### BACKGROUND

There are a wide variety of different types of agricultural equipment. Some such agricultural equipment includes agricultural harvesters. Agricultural harvesters often engage crop, process that crop to obtain harvested material, and unload the harvested material into a material transfer vehicle such as a tractor-pulled grain cart.

Once the material transfer vehicle is filled to a desired fill level, a propulsion vehicle (such as the tractor or other propulsion vehicle) pulls the grain cart to a container, such as a semi-trailer or other haulage vehicle. The propulsion vehicle approaches the semi-trailer, pulls alongside the semi-trailer, and then engages an unloading auger on the grain cart to unload the harvested material from the grain cart into the semi-trailer. During the unloading operation, the propulsion vehicle pulls the grain cart alongside the semi-trailer so that material can be transferred from the grain cart to the semi-trailer according to a desired fill pattern (such as a front-to-back fill pattern, a back-to-front fill pattern, etc.).

The discussion above is merely provided for general background information and is not intended to be used as an aid in determining the scope of the claimed subject matter.

### SUMMARY

An automated ground distance control system automatically controls a propulsion vehicle to travel a desired distance. Operator actuation of a manual override actuator is detected.

Based on the detected actuation, the automated ground distance control system controls the propulsion vehicle to move a manual override distance. In one example, a configuration system exposes an operator interface for configuring the value of the manual override distance.

Example 1 is a vehicle control system, comprising:
a propulsion system configured to provide propulsion to a material transfer vehicle;
an automated ground distance control system configured to automatically control the propulsion system to move the material transfer vehicle a commanded distance;
a manual override actuator; and
a manual override control system configured to detect operator actuation of the manual override actuator and provide a commanded distance signal, indicative of an override distance, to the automated ground distance control system, the automated ground distance control system being configured to automatically control the propulsion system to move the material transfer vehicle the override distance, and then bring the material transfer vehicle to a stop, based on the commanded distance signal.

Example 2 is the vehicle control system of any or all previous examples and further comprising:
a configuration system configured to detect a configuration user input indicative of the override distance and to store the override distance, the manual override control system being configured to retrieve the stored override distance based on detected operator actuation of the manual override actuator.

Example 3 is the vehicle control system of any or all previous examples wherein the manual override actuator comprises:
an actuatable soft button displayed on an operator interface display.

Example 4 is the vehicle control system of any or all previous examples wherein the manual override actuator comprises:
an actuatable hardware button mounted in an operator compartment of the material
transfer vehicle.

Example 5 is the vehicle control system of any or all previous examples wherein the manual override control system comprises:
an actuation type detector configured to detect a type of operator actuation of the manual override actuator and generate a type signal indicative of the detected type of operator actuation.

Example 6 is the vehicle control system of any or all previous examples wherein the manual override control system comprises:
an override distance value processor configured to obtain the override distance based on the type signal and generate an override distance value signal indicative of the obtained override distance.

Example 7 is the vehicle control system of any or all previous examples wherein, when the actuation type detector detects that the type of operator actuation is a single actuation type in which the manual override actuator is actuated a single time over a threshold period, the override distance value processor is configured to generate the override distance value signal to indicate that the override distance value corresponds to the override distance.

Example 8 is the vehicle control system of any or all previous examples wherein, when the actuation type detector detects that the type of operator actuation is a multi-actuation type in which the manual override actuator is actuated a multiple (N) times over the threshold time period, the override distance value processor is configured to generate the override distance value signal to indicate that the override distance value corresponds to N times the override distance.

Example 9 is the vehicle control system of any or all previous examples wherein, when the actuation type detector detects that the type of operator actuation is a press-and-hold actuation type in which the manual override actuator is continuously actuated over the threshold time period, the override distance value processor is configured to generate the override distance value signal to indicate that the automated ground distance control system is to automatically control the propulsion system to move the material transfer vehicle until the manual override actuator is no longer being actuated by the operator.

Example 10 is the vehicle control system of any or all previous examples wherein the actuation type detector is configured to obtain the threshold time period based on when the material transfer vehicle comes to a stop between operator actuations of the manual override actuator.

Example 11 is a method of controlling a material transfer vehicle, the method comprising:
automatically controlling a propulsion system on the material transfer vehicle to move the material transfer vehicle a commanded distance;
detecting operator actuation of a manual override actuator;
identifying an override distance value based on the detected operator actuation of the manual override actuator; and
automatically controlling the propulsion system to move the material transfer vehicle an override distance indicated by the override distance value.

Example 12 is the method of any or all previous examples and further comprising:
automatically controlling the propulsion system to bring the material transfer vehicle to a stop after moving the override distance.

Example 13 is the method of any or all previous examples and further comprising:
detecting a configuration user input;
displaying, on a display device, a configuration actuator;
detecting user actuation of the configuration actuator indicative of the override distance value; and
storing the override distance value.

Example 14 is the method of any or all previous examples wherein identifying the override distance value comprises:
retrieving the stored override distance value based on detected operator actuation of the manual override actuator.

Example 15 is the method of any or all previous examples wherein identifying the override distance value comprises:
detecting a type of operator actuation of the manual override actuator; and
generating a type signal indicative of the detected type of operator actuation.

Example 16 is the method of any or all previous examples wherein identifying the override distance value comprises:
computing the override distance value based on the type signal; and
generating an override distance value signal indicative of the computed override distance value.

Example 17 is the method of any or all previous examples wherein detecting a type of operator interaction comprises detecting that the type of operator actuation is a multi-actuation type in which the manual override actuator is actuated a multiple (N) times over a threshold time period, and wherein computing the override distance value comprises:
computing the override distance value as N times the override distance.

Example 18 is the method of any or all previous examples wherein detecting a type of operator interaction comprises detecting that the type of operator actuation is a press-and-hold actuation type in which the manual override actuator is continuously actuated over the threshold time period, and wherein computing the override distance value comprises:
computing the override distance value to indicate that the propulsion system is to be automatically controlled to move the material transfer vehicle until the manual override actuator is no longer being actuated by the operator.

Example 19 is a vehicle control system, comprising:
a manual override actuator;
at least one processor; and
a datastore storing computer executable instructions which, when executed by the at least one processor, cause the at least one processor to perform steps, comprising:
automatically generating a propulsion control signal to control a propulsion system on a material transfer vehicle to move the material transfer vehicle a commanded distance;
detecting operator actuation of the manual override actuator;
identifying an override distance value based on the detected operator actuation of the manual override actuator; and
automatically generating a control signal to control the propulsion system to move the material transfer vehicle an override distance indicated by the override distance value.

Example 20 is the vehicle control system of any or all previous examples wherein the manual override actuator comprises:
a configurable button displayed on an operator interface display.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a pictorial illustration of one example of an agricultural system including a material transfer vehicle and a semi-trailer.

FIG. 2 is a block diagram showing one example of a control system architecture.

FIG. 3 is a flow diagram illustrating one example of the operation of the control system architecture shown in FIG. 2.

FIG. 4 shows one example of a user interface mechanism.

FIG. 5 is a flow diagram illustrating one example of detecting a type of operator actuation and controlling a propulsion subsystem based upon the type of operator actuation.

FIG. 6 is a flow diagram illustrating one example of configuring the value of the manual override distance.

FIG. 7 shows one example of a user interface mechanism for configuring the value of the manual override distance.

FIG. 8 is a block diagram showing one example of the agricultural system shown in FIG. 2, deployed in a remote server architecture.

FIGS. 9-11 show examples of mobile devices that can be used in the systems and architectures shown in other figures.

FIG. 12 is a block diagram showing one example of a computing environment that can be used in the systems and architectures shown in other figures.

### DETAILED DESCRIPTION

As discussed above, in many agricultural systems, a material transfer vehicle receives harvested material from a harvester and transfers that material, through the field, to a container, such as a semi-trailer. The material transfer vehicle may be a propulsion vehicle (such as a tractor) pulling a grain cart. The material transfer vehicle pulls alongside the container and engages a conveyor (such as an auger) to unload material from the grain cart to the semi-trailer.

Some current agricultural systems include an automated distance control system which automatically controls the material transfer vehicle to move a desired distance that is indicated by a command input. Thus, the automated distance control system may control a clutch, a transmission, an accelerator, a brake, and/or other propulsion mechanisms to control the propulsion vehicle to move the desired distance according to a predefined limit (such as a predefined thrust limit, speed limits, etc.).

There are times, when an operator desires to override the distance control automation. The present description thus describes a system in which a configurable manual override actuator (e.g., button) is provided to allow the operator to override the distance control automation. When the user actuates the manual override actuator, the vehicle is automatically moved by a desired override distance. The override distance can be configured by the operator. In one example, the operator can actuate the manual override actuator using different types of actuation, such as a single-tap actuation, a multi-tap actuation, or a press-and-hold actuation. The propulsion vehicle is controlled to move a different distance, based upon the type of operator actuation detected. There are also times when an operator wishes to move a machine by a pre-programmed distance, even during manual control. For example, during an unload operation, the operator may wish to move the grain cart forward by a given distance, or when backing up to an implement, the operator may wish to move a tractor by a given distance. The system described herein can be used in these scenarios as well.

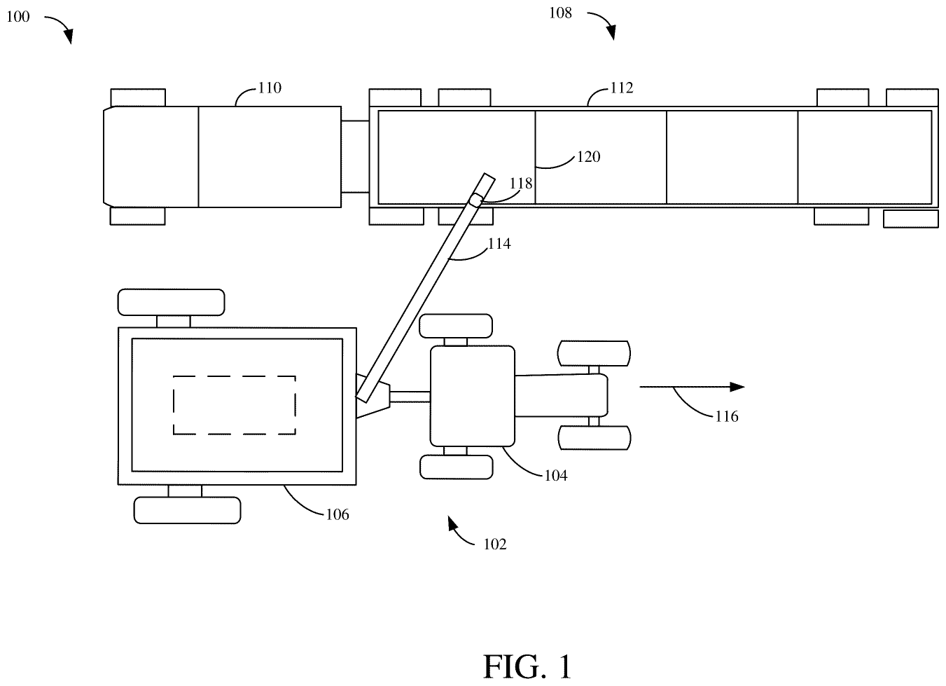

FIG. 1 is a pictorial illustration of one example of an agricultural system 100. Agricultural system 100 shows that a material transfer vehicle 102 (which includes a propulsion vehicle or tractor 104 that tows a grain cart 106) transfers material from a harvester to a container 108, which can include a semi-tractor 110 that pulls a semi-trailer 112. Grain cart 106 includes an auger 114 that moves material from the grain cart 106 to the semi-trailer 112. During an unloading operation, propulsion vehicle 104 may be controlled to move along the side of semi-trailer 112 in the direction indicated by arrow 116 so that material can be transferred to different areas within semi-trailer 112, as desired.

In one example, propulsion vehicle 104 is automatically controlled to control the distance that propulsion vehicle 104 moves before it stops to continue unloading. Also, auger 114 can have an optical sensor 118 mounted near a distal end of auger 114. Optical sensor 118 can detect an image of the interior of semi-trailer 112 so that a fill level of material in semi-trailer 112 can be detected. The propulsion vehicle 104 can be automatically controlled to move in the direction indicated by arrow 116 based upon the detected fill level of material in semi-trailer 112.

However, there may be times when manual override is desired. For instance, it May be that auger 118 is inadvertently positioned to deposit material over a support 120 on semi-trailer 112. In that case, the operator of propulsion vehicle 104 may wish to move grain cart 106 forward by a predefined distance. Thus, the present description describes a system that surfaces a manual override actuator (such as a button) which, when actuated by the operator, automatically causes the control system to move propulsion vehicle 104 in a desired direction (forward or reverse) by a desired and configurable distance.

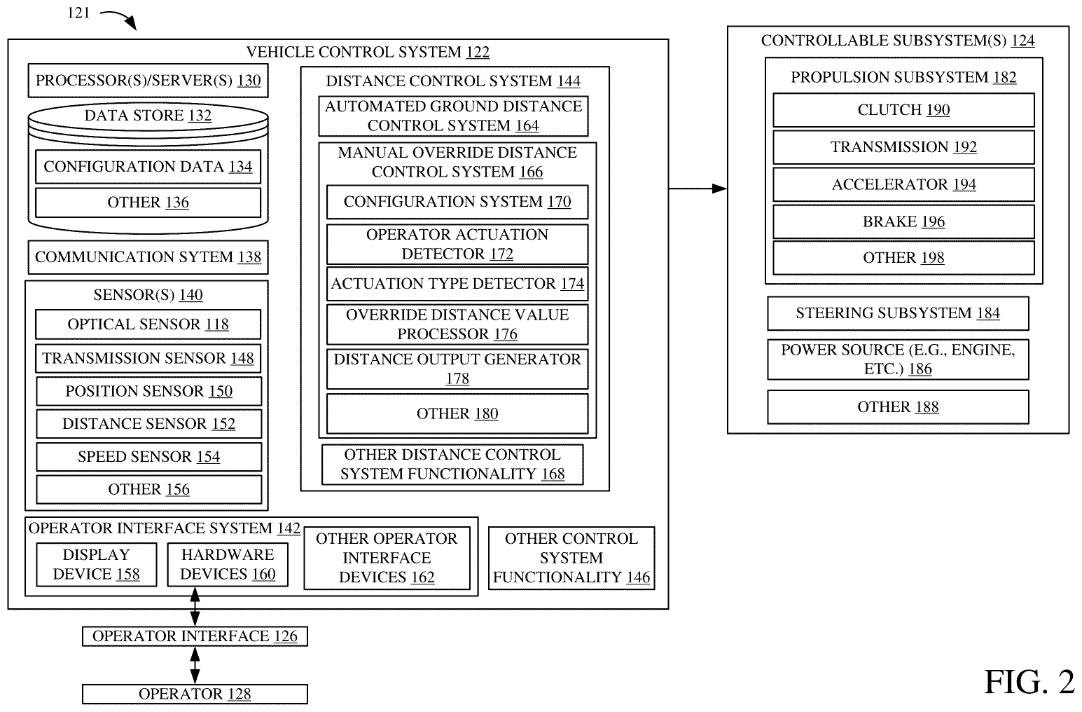

FIG. 2 is a block diagram showing one example of a control system architecture 121 which shows a portion of propulsion vehicle 104 in more detail. FIG. 2 shows that a vehicle control system 122 generates control signals to control one or more controllable subsystems 124. Vehicle control system 122 is also shown generating an operator interface 126 for interaction by operator 128. Operator 128 can interact with operator interface 126 in order to control and manipulate some portions of vehicle control system 122 and controllable subsystems 124.

In the example shown in FIG. 2, vehicle control system 122 can include one or more processors or servers 130, data store 132 (which can include configuration data 134 and other data 136), communication system 138, sensors 140, operator interface system 142, distance control system 144, and other control system functionality 146. Sensors 140 can include optical sensor 118, transmission sensor 148, position sensor 150, distance sensor 152, speed sensor 154, and other sensors 156. Operator interface system 142 can include display device 158, hardware devices 160, and/or other operator interface devices 162. Distance control system 144 can include automated ground distance control system 164, manual override distance control system 166, and other distance control system functionality 168. Manual override distance control system 166 can include configuration system 170, operator actuation detector 172, actuation type detector 174, override distance value processor 176, distance output generator 178, and other items 180.

Controllable subsystems on propulsion vehicle 104 can include propulsion subsystem 182, steering subsystem 184, power source (e.g., engine, motor, etc.) 186, and any of a wide variety of other controllable subsystems 188. Propulsion subsystem 182 can include clutch 190, transmission 192, accelerator 194, brake 196, and other items 198.

On controllable subsystems 124, propulsion subsystem 182 includes a controllable subsystem that causes vehicle 104 to move in the forward or rearward direction at a desired speed and acceleration. Clutch 190 can be a shift clutch for use in shifting transmission 192 between gears or another type of clutch for use in changing the position of other types of transmission. Transmission 192 can be any of a wide variety of different types of transmissions, such as a continuously variable transmission, an infinitely variable transmission, a power shift transmission, among others.

Accelerator 194 can include a mechanism that causes the power source 186 (e.g., the engine) to increase in engine speed. Accelerator 194 may be mechanical, hydraulic, electro-mechanical, electro-hydraulic, or another type of accelerator 194.

Brake 196 can also be a mechanism that applies brakes or is otherwise used to decelerate vehicle 104. Brake 196 can be mechanical, hydraulic, electro-hydraulic, electric, electrically operated mechanical, or another brake system. Control signals generated by vehicle control system 122 can be used to control actuators that move clutch 190, transmission 192, accelerator 194, and/or brake 196 to different positions to perform clutching, shifting, acceleration, and braking operations, among others.

Steering subsystem 184 can include a steering wheel and linkage or other mechanism for steering front wheels or rear wheels of vehicle 104, or for steering all wheels of vehicle 104. Similarly, the wheels of vehicle 104 can be steered in pairs or other ground-engaging elements, such as a tracks, can be steered using a skid steer mechanism. Thus, the control signals generated by vehicle control system 122 can control actuators that manipulate steering subsystem 184 to steer or change the heading of vehicle 104.

Power source 186 may be an internal combustion engine, an electric motor, a hybrid engine, or another type of motor or mechanism that provides force to propel vehicle 104 in a forward direction of travel or a rearward direction of travel. Power source 186 can provide force to the ground-engaging elements through transmission 192. There may be a plurality of different power sources 186 that drive the ground-engaging elements individually or in sets, or a single power source 186 that drives individual ground-engaging elements, or sets of ground-engaging elements, or subsets of ground-engaging elements through a transmission or otherwise.

Before describing the overall operation of vehicle control system 122 in more detail, a description of some of the items in control system architecture 121 and their operation will first be described.

Communication system 138 facilitates the communication of items in control system architecture 121 with one another and may also facilitate communication of propulsion vehicle 104 with other vehicles or other systems. Therefore, communication system 138 can include a controller area network (CAN) bus and bus controller, a cellular communication system, a Wi-Fi or Bluetooth communication system, a wide area network communication network, a local area network communication system, a near field communication system network, and/or any of a wide variety of other communication systems that communicate over other communication system networks or combinations of networks.

Optical sensor 118 may include a mono or stereo camera or another optical sensor that captures images in a field of view (or sensor range), along with an image processing system that processes those images to obtain desired data from the captured images. The sensor signal from optical sensor 118 may be used with a guidance system for steering propulsion vehicle 104, for avoiding obstacles, and/or for detecting a fill level within semi-trailer 112.

Transmission sensor 148 can be a transmission position sensor or transmission range sensor that can provide information indicating the currently engaged gear of a transmission 192 that is being used to apply force from power source 186 to wheels or other ground-engaging elements. Transmission sensor 148 can also be used to detect information about other transmissions, such as hydrostatic drive systems, etc., and whether propulsion vehicle 104 is traveling is the forward or rearward direction.

Position sensor 150 generates a sensor signal indictive of a position of sensor 150 in a global or local coordinate system. Therefore, position sensor 140 may be a global navigation satellite system (GNSS) receiver, a cellular triangulation system, a dead reckoning system, or another sensor system. Distance sensor 152 can detect information that can be used to determine a distance that vehicle 104 travels. The distance sensor 152 can be used to measure travel distance in a variety of different ways. For instance, distance sensor 152 can accumulate wheel speed pulse counts that occur in a drive train of vehicle 104 as vehicle 104 is being driven. The wheel speed pulse count can be converted to a distance based on an axle ratio and a rolling radius of wheels or other ground-engaging elements on vehicle 104. Distance sensor 152 can sense the output of a motor (e.g., the number of revolutions of the motor) or power source 186 that is driving the ground-engaging elements as well as the signal from transmission sensor 148 and use that information to derive travel distance. Distance sensor 152 can also derive the distance traveled by vehicle 104 based upon inputs from other sensors. For instance, a plurality of sensor signals indicating multiple different positions, generated by position sensor 150, can be used to identify the distance that vehicle 104 has traveled. Distance sensor 152 can also be an optical sensor that calculates distance traveled by capturing images of the area around vehicle 104 and processing those images to determine a travel distance. Distance sensor 152 can also include a counter that increments as vehicle 104 travels in the forward direction and decrements as the vehicle transfers in the reward direction. The counts, along with the travel speed of vehicle 104 sensed by speed sensor 154 can be used to estimate or calculate the travel distance.

Speed sensor 154 generates a signal indicative of a ground speed or rate of travel of vehicle 104. Speed sensor 154 may also provide an output from which the rate of acceleration and/or deceleration of vehicle 104 can be determined. Speed sensor 154 can thus be a speedometer, a sensor that senses the speed of rotation of the ground-engaging elements (wheels or tracks), the speed of rotation of a drive shaft or an axle, an inertial measurement unit (IMU), or another type of sensor.

Automated ground distance control system 164 generates a control signal to control propulsion subsystem 182 on vehicle 104 to move vehicle 104 by a desired distance. Automated ground distance control system 164 can identify a current location of vehicle 104, as well as a target location for vehicle 104, and generate a travel distance request, as well as a speed/acceleration limit request and a maximum thrust limit request. The various requests can come from operator inputs, from stored data in data store 132, or from other elements. Automated ground distance control system 164 then generates a travel plan for controlling propulsion subsystem 182 to move the desired distance at the desired speed and acceleration, without exceeding the limits. As vehicle 104 moves, distance sensor 152 senses the travel distance and automated ground distance control system 164 detects whether vehicle 104 is approaching its target location. If so, automated ground distance control system 164 controls propulsion subsystem 182 to decelerate and stop vehicle 104 according to the travel plan and identify a location at which vehicle 104 resides, once it is stopped. If that location is within a tolerance threshold of the target location, then vehicle 104 can perform other automated operations or manually-initiated operations, such as to begin unloading harvested material from grain cart 106 into semi-trailer 112. If the current location of vehicle 104 is not within the distance threshold, then automated ground distance control system 164 automatically moves vehicle 104 forward or rearward until it is within the distance threshold of the target location.

Manual override distance control system 166 can be used to manually override the automated ground distance control system 164, and to move vehicle 104 by a pre-programmed distance even when vehicle 104 is under manual control. For instance, if vehicle 104 stops in a position where unloading auger 118 is unloading material onto cross member (or support) 120, the operator of vehicle 104 may wish to move vehicle 104 slightly forward or rearward. Thus, in one example, operator interface system 142 exposes an operator interface with a manual override actuator that operator 128 can actuate. Display device 158 may thus be a display screen that displays and operator actuatable mechanism, such as a link, an icon, a button, etc. as the manual override actuator. The mechanism can be actuated by operator 128 using a point and click device or using a touch gesture (where device 158 is a touch screen) or using voice commands (where speech recognition and/or speech synthesis are provided, for instance) or in other ways. Operator interface 126 may also include a hardware device which serves as the manual override actuator, such as a button on the dashboard or other control panel of vehicle 104. In that case, operator 128 actuates the manual override actuator by depressing the button. Other operator interface devices 162 can include other audio, visual, and/or haptic devices that provide outputs to operator 128 and that may receive inputs from operator 128.

Operator actuation detector 172 detects operator actuation of the manual override actuator. For instance, operator actuation detector 172 can receive a message or other signal from operator interface system 142 indicating that operator 128 has actuated the manual override actuator. Actuation type detector 174 detects the type of actuation. For instance, it may be that operator 128 actuates the manual override actuator by depressing or tapping a button once. It May be that operator 128 actuates the manual override actuator by repeatedly tapping or depressing a button a plurality of different times within a time period. It may also be that operator 128 actuates the manual override actuator by pressing and holding or touching and holding the manual override actuator for a threshold period of time. The type of actuation is output by actuation type detector to override distance value processor 176.

Override distance value processor 176 computes (e.g., calculates, retrieves from memory, or otherwise obtains) the distance that will be commanded to automated ground distance control system 164 to move vehicle 104 in response to operator actuation of the manual override actuator based on the type of actuation. For instance, if operator 128 actuates the manual override actuator by selecting or depressing the button once, then override distance value processor 176 may access configuration data 134 indicating the override distance value which represents the distance by which control system 164 will be commanded to move vehicle 104 based upon a single depression or selection of the manual override actuator. However, if actuation type detector 174 detects that operator 128 has actuated the manual override actuator a plurality of times within a time period, then override distance value processor 176 may multiply the override distance value in configuration data 134 by the number of times that operator 128 depressed the manual override actuator.

By way of example, assume that the override distance value in configuration data 134 is 18 inches, meaning that if operator 128 actuates the manual override actuator once, then override distance value processor 176 will compute the override distance value as 18 inches. Distance output generator 178 will generate an output indicative of that distance (18 inches) as a commanded distance to automated ground distance control system 164 which, itself, will generate a control signal to control propulsion subsystem 182 to move vehicle 104 by the commanded distance. However, if actuation type detector 174 detects that operator 128 has actuated the manual override actuator a number N (e.g., two) times within a predetermined time period (such as before the vehicle 104 is moved and stopped based on the first actuation), then override distance value processor 176 may compute the override distance as 36 inches (or N times the override distance value for one actuation) because operator 128 actuates the manual override actuator two times (N=2).

If actuation type detector 174 detects that operator 128 has pressed and held the manual override actuator, then override distance value processor 176 provides a signal to distance output generator 178 causing distance output generator 178 to continue to update the commanded distance signal output to automated ground distance control system 164 so that automated ground distance control system 164 controls propulsion subsystem 182 to continue moving vehicle 104 in the current direction until the actuation type detector 174 detects that operator 128 has stopped actuating (stopped depressing) the manual override actuator. At that point, distance output generator 178 provides an output to automated ground distance control system 174 indicating that system 164 should control propulsion subsystem 182 to stop vehicle 104.

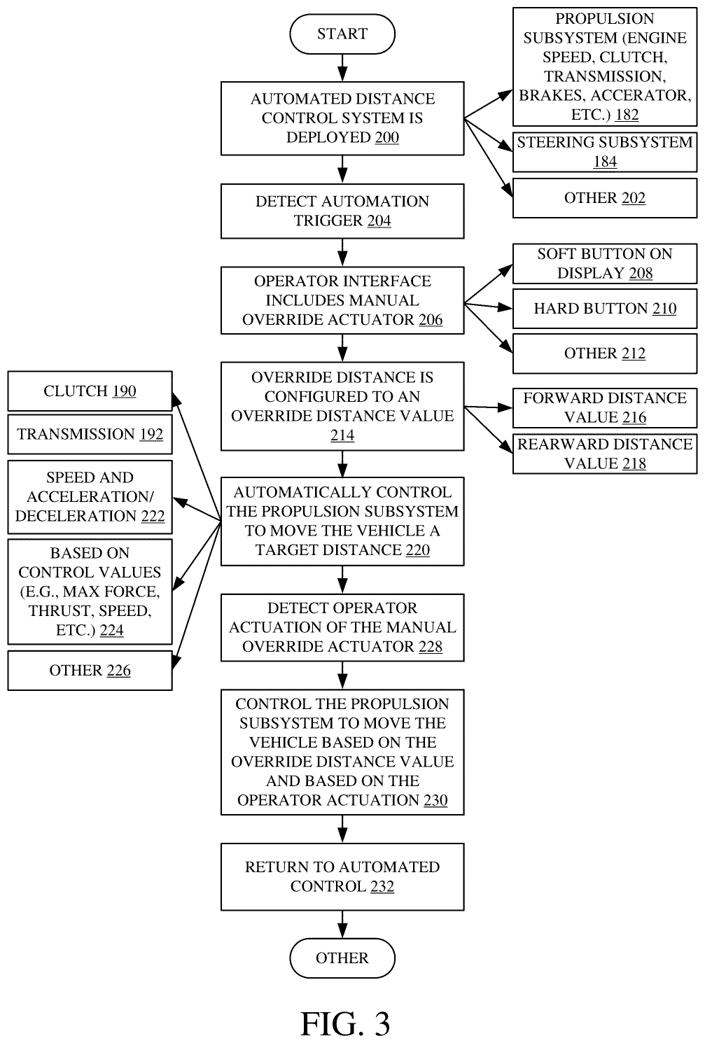

FIG. 3 is a flow diagram illustrating one example of the operation of vehicle control system 122 in more detail in which manual override distance control system 166 overrides automated ground distance control system 164. It will be appreciated, however, that manual override distance control system 166 can be used to move the vehicle 104 a predefined distance, even when vehicle 104 is being controlled manually. The description with respect to FIG. 3 is by way of example only.

It is first assumed that the automated ground distance control system 164 is deployed on vehicle 104 so that vehicle 104 can be automatically controlled to travel a commanded distance based on a distance command signal it receives. Having control system 164 deployed on vehicle 104 is indicated by block 200 in the flow diagram of FIG. 3. In one example, control system 164 is deployed to automatically control propulsion subsystem 182 which may include controlling engine speed, controlling clutch 190, transmission 192, brakes 196, accelerator 194, etc. In one example, vehicle control subsystem 122 may also automatically control steering subsystem 184. The automation in vehicle control system 122 can be used to automatically control other functions as well, as indicated by block 202.

At some point, distance control system 144 detects a trigger that causes distance control system 144 to begin automatically controlling the distance travelled by vehicle 104. Detecting an automation trigger is indicated by block 204 in the flow diagram of FIG. 3. The automation trigger can be an operator input through operator interface system 142, an automated input, or another input.

In one example, when distance control system 144 is automatically controlling propulsion subsystem 182 based on a distance command signal, operator interface system 142 generates or includes an operator interface that includes a manual override actuator, as indicated by block 206. The manual override actuator may be a soft button (such as an actuatable button displayed on a display screen) as indicated by block 208, or a hard button (such as a hardware button on a control panel or dashboard in an operator compartment of vehicle 104) as indicated by block 210. The manual override actuator can also be any of a variety of other operator actuatable input mechanisms, as indicated by block 212.

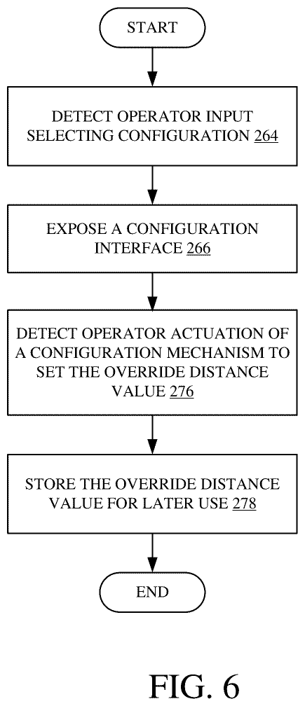

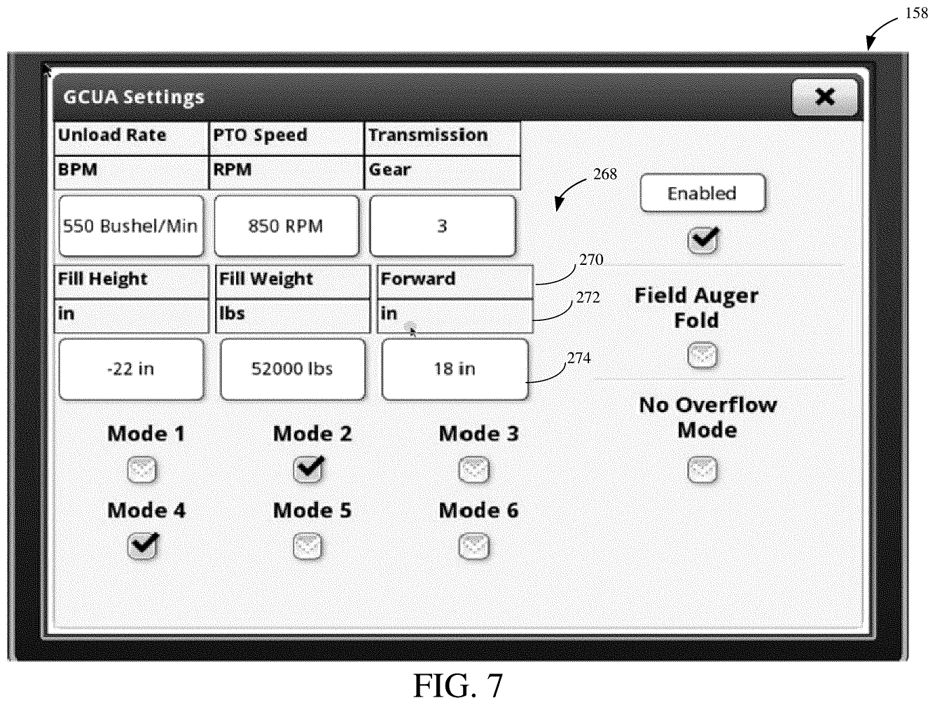

It is also assumed for the purposes of describing FIG. 3 that an operator 128 or another user has already used configuration system 170 to configure the override distance associated with the manual override actuator. Configuration of the override distance as configuration data 134 is illustrated by block 214 in the flow diagram of FIG. 3 and is described in more detail below with respect to FIGS. 6 and 7. Suffice it to say, for now, that the configuration data identifies an override distance value indicative of a distance that vehicle 104 is to be moved in a forward direction, as indicated by block 216, or a distance value indicative of a distance that vehicle 104 is to be moved in the rearward direction (or reverse direction, opposite the forward direction) as indicated by block 218, based on a single actuation of the manual override actuator.

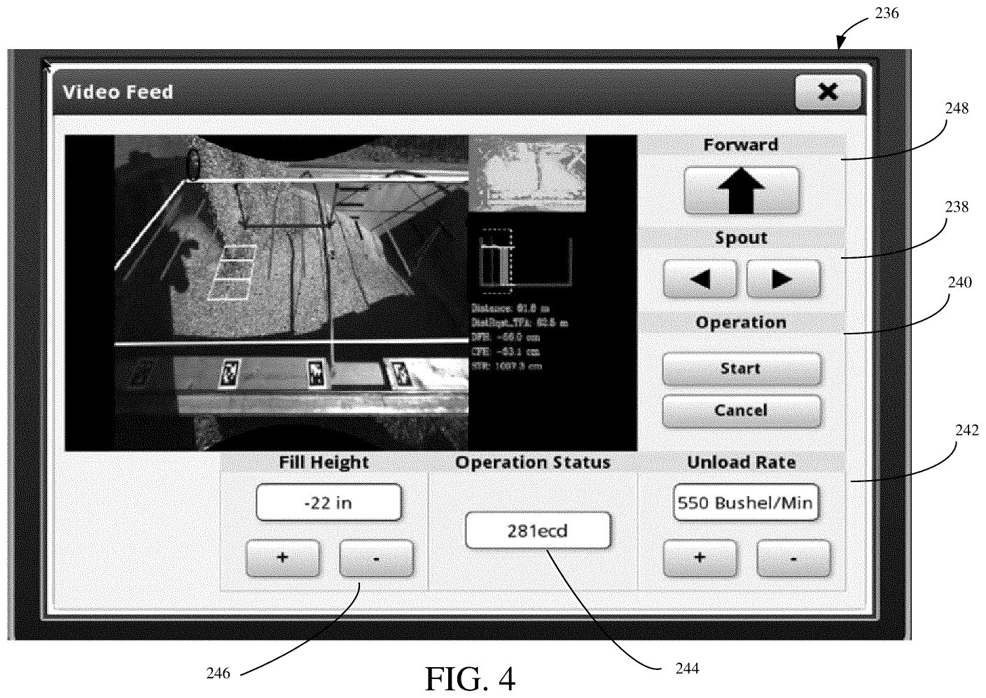

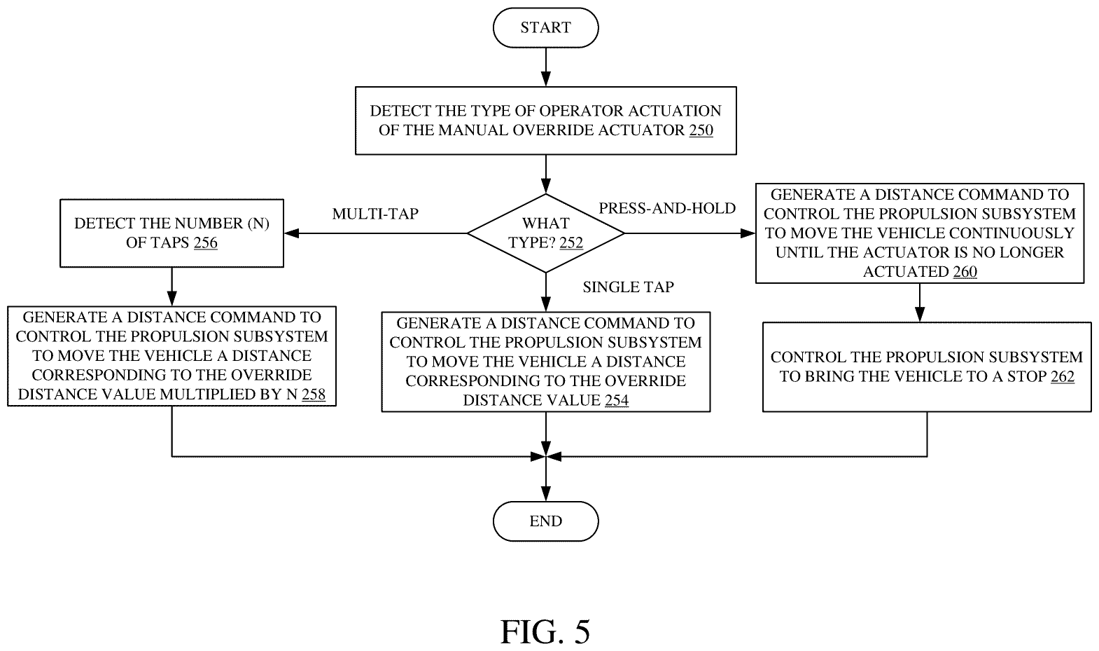

Before continuing with the description of FIG. 3, an example of a user interface mechanism will now be described. FIG. 4 shows one example of a user interface mechanism 236 that can be used to generate operator interface 126. In the example shown in FIG. 4, user interface mechanism 236 is a display device displaying a user interface display that has a plurality of different actuators, such as spout actuators 238 that can be used to control the position of the auger or spout on the grain cart, operation start and stop actuators 240 that can be used to start and stop operations, an unload rate actuator 242 that can be used to set a rate at which material is unloaded from grain cart 106 into semi-trailer 112, an operation status indicator 244 that indicates a status of a current operation, a set of fill height actuators 246 that can be used to set the fill height of material in semi-trailer 112 relative to the top of semi-trailer 112, as well as a manual override actuator 248. In the example shown in FIG. 4, manual override actuator 248 is configured as a “forward” button that is a soft button in that it is displayed on a user interface display and can be actuated using a point and click device and/or a touch gesture. When the manual override actuator 248 is actuated by operator 128, then based on the type of actuation, manual override distance control system 164 commanding an output to automated ground distance control system 164 indicating a distance by which system 164 is to control vehicle 104 to move in the forward direction. For instance, if manual override actuator 248 is configured to cause an 18 inch forward movement, then when operator 128 actuates (taps, depresses, or otherwise actuates) manual override actuator 248, automated ground distance control system 164 controls propulsion subsystem 182 to move vehicle 104 forward by 18 inches. Instead, or in addition, the manual override actuator 248 may be a “reverse” actuator so that when it is actuated by operator 128, vehicle 104 is controlled to move in the reverse direction by the manual override distance to which the reverse actuator is configured. As discussed in more detail below with respect to FIG. 5, the vehicle 104 will be controlled to move differently based upon the different types of actuation of manual override actuator 248. For instance, if actuator 248 is actuated twice within a predetermined time period, then vehicle 104 will be controlled to move in the forward direction two times the manual override distance (or 36 inches). Other actuation types are described in greater detail below.

Now continuing with the description of FIG. 3, as discussed above, distance control system 144 can use automated ground distance control system 164 to automatically control the propulsion subsystem 182 to move vehicle 104 to a target location or a target distance, as indicated by block 220 in the flow diagram of FIG. 3, based on a distance command signal. For instance, the current location of vehicle 104 can be sensed using position sensor 150, and a target location of vehicle 104 can be received by an operator input or an automated input, or otherwise. Automated ground distance control system 164 can then begin to generate control signals to control clutch 190, transmission 192, the speed, and the acceleration/deceleration of vehicle 104 (such as by controlling accelerator 194 and brake 196) as indicated by block 222 in the flow diagram of FIG. 3. Automated ground distance control system 164 can also control propulsion subsystem 182 based on control values such as a maximum force or thrust value, a maximum speed value, etc., as indicated by block 224 in the flow diagram of FIG. 3. Automated ground distance control system 164 can control propulsion system 182 in other ways, based on other values as well, as indicated by block 226 in the flow diagram of FIG. 3.

At some point, operator 128 actuates the manual override actuator 248, and this actuation is detected by operator actuation detector 172. The actuation of the manual override actuator 248 can be detected on operator interface system 142 and communicated to operator actuation detector 172, or the actuation can be detected in other ways. Detecting operator actuation of the manual override actuator 248 is indicated by block 228 in the flow diagram of FIG. 3.

Manual override distance control system 166 then generates a command to automated ground distance control system 164 so that automated ground distance control system 164 controls the propulsion subsystem 182 to move the vehicle 104 based upon the override distance value and based upon the type of actuation that operator 128 used to actuate the manual override actuator 248. Controlling the propulsion subsystem 182 in this way is indicated by block in the flow diagram of FIG. 3 and is described in greater detail below with respect to FIG. 5.

Once automated ground distance control system 164 controls propulsion subsystem 182 to travel a distance based on the override distance value, the automated ground distance control system 164 controls the propulsion subsystem 182 to bring vehicle 104 to a stop and/or resumes automated control of the controllable subsystems 124. Returning to automated control of the controllable subsystems 124 is indicated by block 232 in the flow diagram of FIG. 3.

FIG. 5 is a flow diagram illustrating one example of the operation of actuation type detector 174 and override distance value processor 176. Actuation type detector 174 detects the type of operator actuation of the manual override actuator 248, as indicated by block 250 in the flow diagram of FIG. 5. In the example described with respect to FIG. 5, the type of actuation can be a single tap actuation (where the operator 128 depressed manual override actuator 248 once and released the actuator), a multi-tap actuation, where the operator 128 depresses or otherwise actuates manual override actuator 248 multiple times within a predetermined time period, and a press-and-hold actuation where operator 128 depresses or otherwise actuates manual override actuator 248 continuously for a given time period. When the type of actuation is determined (as indicated by blocks 250 and 252 in FIG. 5) to be a single tap actuation, then distance override value processor 176 computes the override distance as that distance in configuration data 134 associated with a single actuation of manual override actuator 248. A distance output generator 178 then generates a distance command to control system 164 to control the propulsion subsystem 182 to move the vehicle 104 a distance corresponding to the override distance value in configuration data 134. Generating such a distance command is indicated by block 254 in the flow diagram of FIG. 5.

If the actuation of manual override actuator 248 is determined to be a multi-tap actuation, as indicated by blocks 250 and 252 in the flow diagram of FIG. 5, then this indicates that operator 128 has actuated manual override actuator 248 multiple times within a predetermined time period. In one example, if operator 128 actuates manual override actuator 248 once and control system 164 begins to move vehicle 124 by the override distance, but operator 128 again actuates manual override actuator 248 before the vehicle 104 has come to a stop from the first actuation, then the actuation is determined to be a multi-tap actuation. In that case, actuation type detector 174 also detects the number of taps or actuations within the predetermined time period, as indicated by block 256. For instance, if operator 128 actuates the manual override actuator 248 three times in rapid succession (so that vehicle 104 has not yet come to a stop after the first or second actuation), then actuation type detector 174 generates an output indicating that the type of actuation is a multi-tap actuation, along with the number of actuations (N) that were detected within the predetermined time period. Based on the type indicator that the actuation was a multi-tap actuation, and based on the number (N) of actuations, override distance value processor 176 computes a distance output indicative of N times the override distance value corresponding to a single actuation of manual override actuator 248. For example, if operator 128 actuates manual override actuator 248 three times in rapid succession, then override distance value processor 176 computes the override distance to be three times the single actuation distance (or three times 18 inches=54 inches). Distance output generator 178 then generates a distance command indicating that vehicle 104 should be controlled to move forward 54 inches based on the actuation of the manual override actuator 248. Generating such a distance command is indicated by block 258 in the flow diagram of FIG. 5.

Now assume that actuation type detector 174 has detected that operator 128 has depressed and held manual override actuator 248 in the depressed position for a threshold time period. In that case, actuation type detector 174 generates an output indicating that the actuation of the manual override actuator 248 is a press-and-hold type of actuation and that the manual override actuator 248 is still being actuated (or pressed). In response, override distance value processor 176 computes the override distance value as a value that keeps increasing until operator 128 releases manual override actuator 248. Distance output generator 178 generates a distance command indicative of this distance, or another output instructing automated ground distance control system 164 to continuously control vehicle 104 to move forward until a stop signal is generated by distance output generator 178. In either case, distance output generator 178 generates a command to automated ground distance control system 164 to move the vehicle 104 continuously until the manual override actuator 248 is no longer being actuated by operator 128, as indicated by block 260 in the flow diagram of FIG. 5. In response, automated ground distance control system controls the propulsion subsystem 182 to move vehicle 104 forward and to bring the vehicle to a stop, once the manual override actuator 248 is released by operator 128, as indicated by block 262 in the flow diagram of FIG. 5.

FIG. 6 is a flow diagram illustrating one example of the operation of configuration system 170 in allowing operator 128 or another user to enter configuration data 134 configuring the distance that vehicle 104 will be moved in response to a single actuation of the manual override actuator 248. In the example described herein, it will be assumed that operator 128 is the user who enters the configuration data. It will be appreciated, however, that other users, technicians, or operators could enter the configuration data as well.

Configuration system 170 detects an operator input indicating that the operator 128 wishes to configure the manual override actuator 248. In one example, the operator 128 can provide an input through a display screen displayed on an operator interface 126 or another input selecting configuration. Detecting an operator input indicating operator 128 wishes to enter configuration information is indicated by block 264 in the flow diagram of FIG. 6.

Configuration system 170 can then control operator interface system 142 to expose a configuration interface that operator 128 can manipulate in order to enter the configuration data. Exposing a configuration interface is indicated by block 266 in FIG. 6. The configuration interface can include a text box where the manual override distance value can be entered, a set of +/−actuators, a dropdown menu, a scroll wheel, a slider, or any other configuration interface.

Before continuing with a description of FIG. 6, one example of a configuration interface will be described. FIG. 7 shows one example of a display device 158 that displays a configuration interface with actuators that can be actuated by operator 128 in order to enter configuration data. FIG. 7 shows that the display includes a configuration mechanism 268 that can be used to enter a distance corresponding to the “forward” button 248 shown in FIG. 4. In the example shown in FIG. 7, actuator 268 includes an identifier 270 that identifies that the configuration data will correspond to the “forward” button 248. Actuator 268 also includes a units actuator 272 that can be actuated to select units (such as inches, feet, meters, etc.). The actuator 268 also includes a value actuator 274 that can be used to input the distance value. In the example shown in FIG. 7, the distance value is set to 18 inches.

Referring again to FIG. 6, detecting operator actuation of the configuration actuator 268 to set an override distance value as configuration data is indicated by block 276 in the flow diagram of FIG. 6. Once the operator exits the configuration screen, then configuration system 170 stores the entered configuration data (the 18 inch override distance value) as configuration data 134 in data store 132 for later use during a manual override operation. Storing the override distance value is indicated by block 278 in the flow diagram of FIG. 6.

It can thus be seen that the present description describes a system in which a propulsion system of a vehicle 104 can be controlled automatically using an automated control system, but that automated control system can easily be manually overridden by using a configurable manual override actuator. This allows for more precise positioning of vehicles during unloading operations or other operations.

The present discussion has mentioned processors and servers. In one example, the processors and servers include computer processors with associated memory and timing circuitry, not separately shown. The processors and servers are functional parts of the systems or devices to which the processors and servers belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, buttons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays them has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, actuators, detectors, generators, sensors, and/or logic. It will be appreciated that such systems, components, actuators, detectors, generators, sensors, and/or logic can be comprised of hardware items (such as processors and associated memory, or other processing components, some of which are described below) that perform the functions associated with those systems, components, actuators, detectors, generators, sensors, and/or logic. In addition, the systems, components, actuators, detectors, generators, sensors, and/or logic can be comprised of software that is loaded into a memory and is subsequently executed by a processor or server, or other computing component, as described below. The systems, components, actuators, detectors, generators, sensors, and/or logic can also be comprised of different combinations of hardware, software, firmware, etc., some examples of which are described below. These are only some examples of different structures that can be used to form the systems, components, actuators, detectors, generators, sensors, and/or logic described above. Other structures can be used as well.

It will also be noted that the information on map 107 can be output to the cloud.

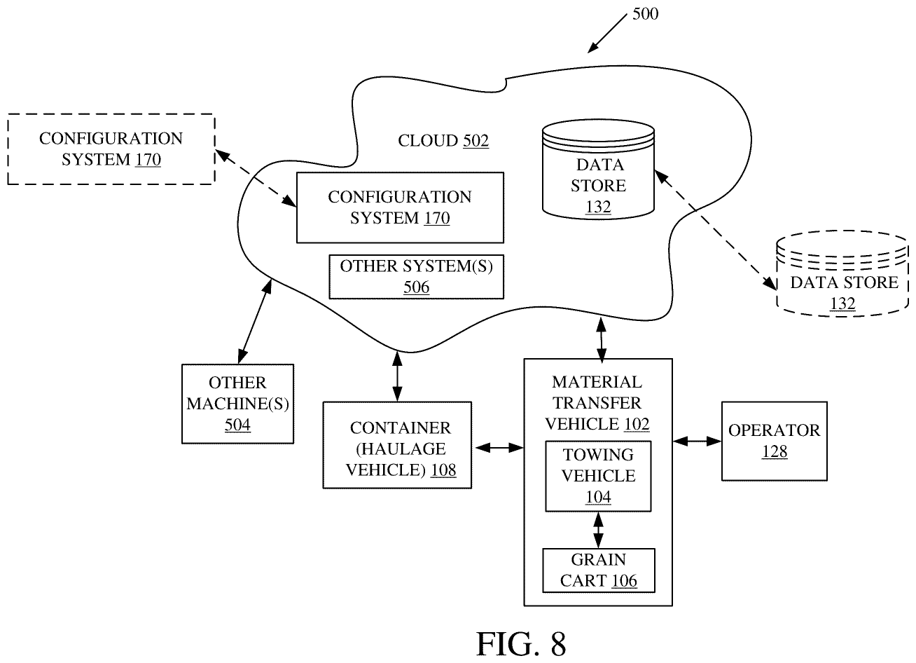

FIG. 8 is a block diagram of agricultural system 100, shown in FIG. 1, except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though the data centers appear as a single point of access for the user. Thus, the components and functions described herein can be provided from a remote server at a remote location using a remote server architecture. Alternatively, the components and functions can be provided from a conventional server, or the components and functions can be installed on client devices directly, or in other ways.

In the example shown in FIG. 8, some items are similar to those shown in previous FIGS. and they are similarly numbered. FIG. 8 specifically shows that configuration system 170 and data store 132 can be located at a remote server location 502. Therefore, vehicle 104 accesses those systems through remote server location 502. FIG. 8 also shows that other machines (vehicles) and/or other systems 506 can be included in agricultural system 100 as well.

FIG. 8 also depicts another example of a remote server architecture. FIG. 8 shows that it is also contemplated that some elements of previous FIGS are disposed at remote server location 502 while others are not. By way of example, configuration system 170 or data store 132 can be disposed at a location separate from location 502, and accessed through the remote server at location 502. Regardless of where the items are located, the items can be accessed directly by vehicle 104, through a network (either a wide area network or a local area network), the items can be hosted at a remote site by a service, or the items can be provided as a service, or accessed by a connection service that resides in a remote location.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

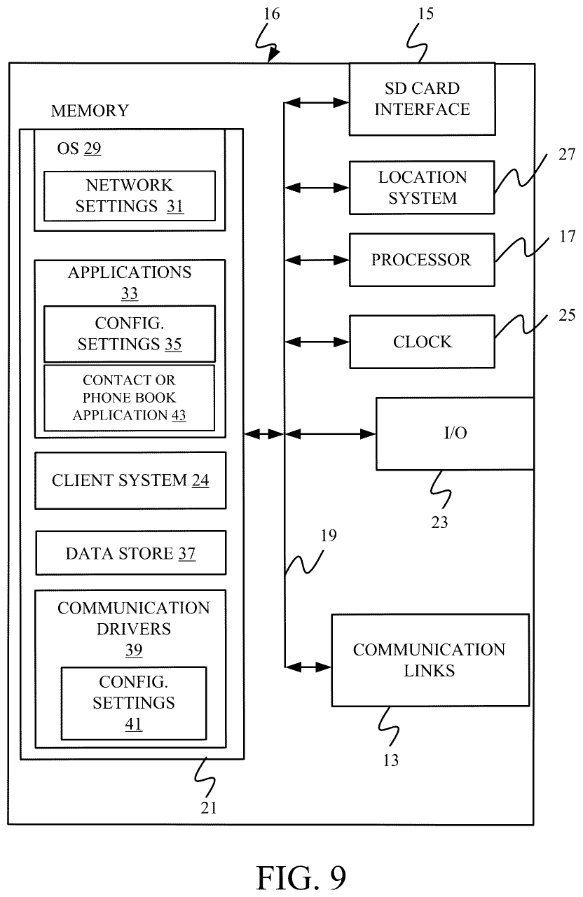

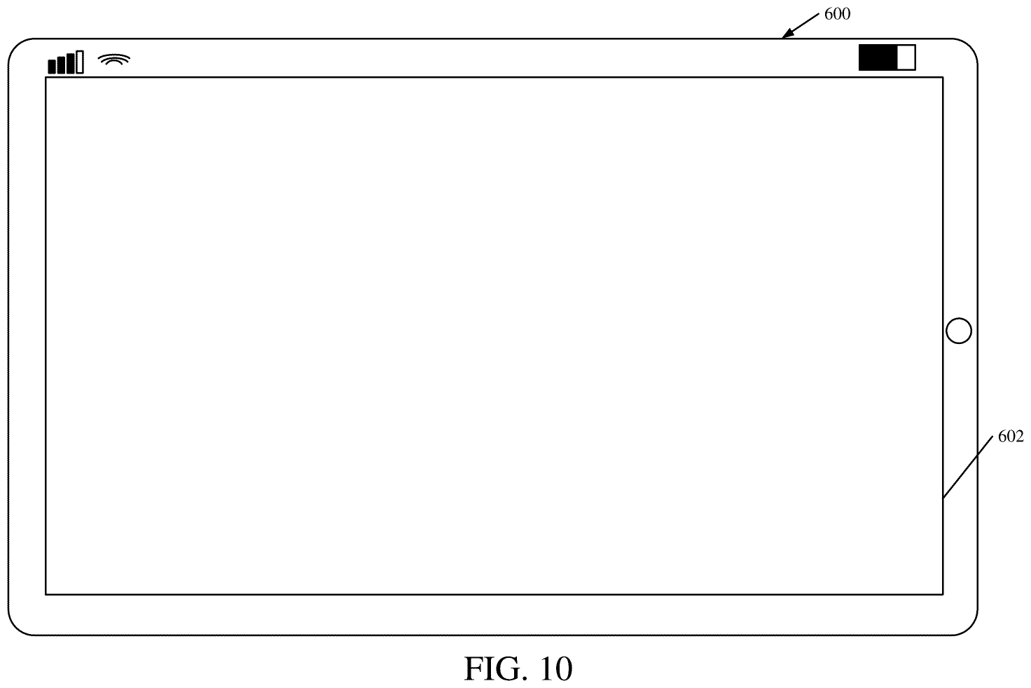

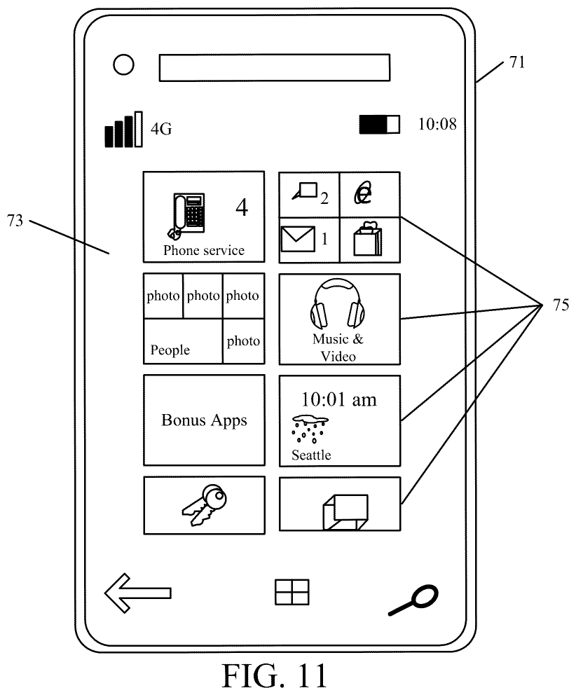

FIG. 9 is a simplified block diagram of one illustrative example of a handheld or mobile computing device that can be used as a user's or client's hand held device 16, in which the present system (or parts of it) can be deployed. For instance, a mobile device can be deployed in the operator compartment of vehicle 104 for use in generating, processing, or displaying the manual override actuator and configuration display. FIGS. 10-11 are examples of handheld or mobile devices.

FIG. 9 provides a general block diagram of the components of a client device 16 that can run some components shown in other FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 10 shows one example in which device 16 is a tablet computer 600. In FIG. 10, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

FIG. 11 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

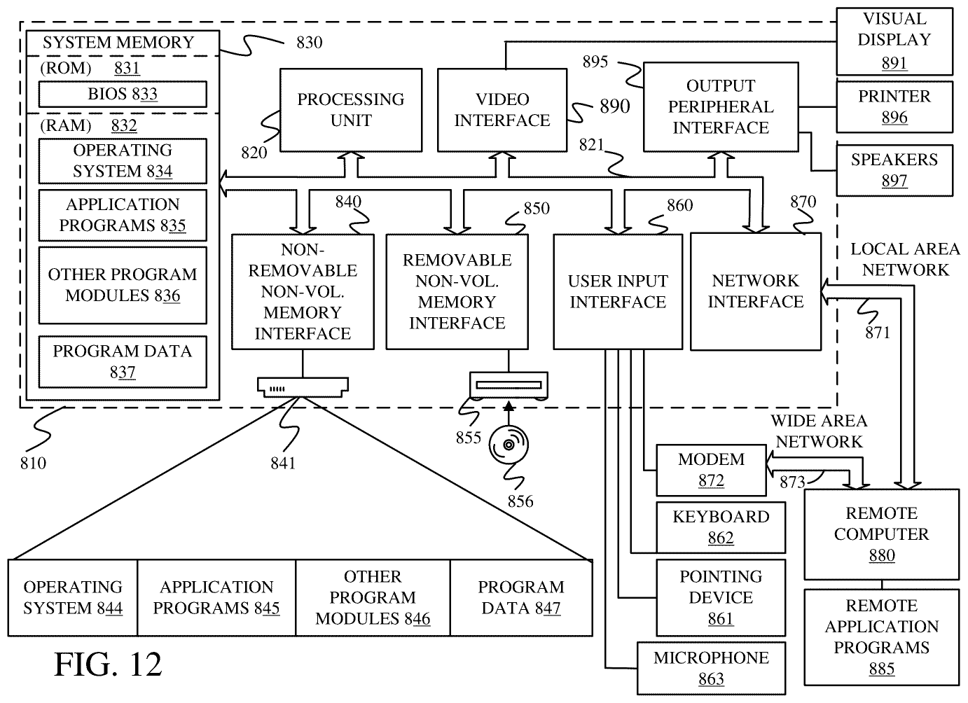

FIG. 12 is one example of a computing environment in which elements of previous FIGS., or parts of it, (for example) can be deployed. With reference to FIG. 12, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 12.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network-CAN, local area network-LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 12 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A vehicle control system, comprising:
a propulsion system configured to provide propulsion to a material transfer vehicle;
an automated ground distance control system configured to automatically control the propulsion system to move the material transfer vehicle a commanded distance;
a manual override actuator; and
a manual override control system configured to detect operator actuation of the manual override actuator and provide a commanded distance signal, indicative of an override distance, to the automated ground distance control system, the automated ground distance control system being configured to automatically control the propulsion system to move the material transfer vehicle the override distance, and then bring the material transfer vehicle to a stop, based on the commanded distance signal.

2. The vehicle control system of claim 1 and further comprising:
a configuration system configured to detect a configuration user input indicative of the override distance and to store the override distance, the manual override control system being configured to retrieve the stored override distance based on detected operator actuation of the manual override actuator.

3. The vehicle control system of claim 1 wherein the manual override actuator comprises:
an actuatable soft button displayed on an operator interface display.

4. The vehicle control system of claim 1 wherein the manual override actuator comprises:
an actuatable hardware button mounted in an operator compartment of the material transfer vehicle.

5. The vehicle control system of claim 1 wherein the manual override control system comprises:
an actuation type detector configured to detect a type of operator actuation of the manual override actuator and generate a type signal indicative of the detected type of operator actuation.

6. The vehicle control system of claim 5 wherein the manual override control system comprises:
an override distance value processor configured to obtain the override distance based on the type signal and generate an override distance value signal indicative of the obtained override distance.

7. The vehicle control system of claim 6 wherein, when the actuation type detector detects that the type of operator actuation is a single actuation type in which the manual override actuator is actuated a single time over a threshold period, the override distance value processor is configured to generate the override distance value signal to indicate that the override distance value corresponds to the override distance.

8. The vehicle control system of claim 6 wherein, when the actuation type detector detects that the type of operator actuation is a multi-actuation type in which the manual override actuator is actuated a multiple (N) times over the threshold time period, the override distance value processor is configured to generate the override distance value signal to indicate that the override distance value corresponds to N times the override distance.

9. The vehicle control system of claim 6 wherein, when the actuation type detector detects that the type of operator actuation is a press-and-hold actuation type in which the manual override actuator is continuously actuated over the threshold time period, the override distance value processor is configured to generate the override distance value signal to indicate that the automated ground distance control system is to automatically control the propulsion system to move the material transfer vehicle until the manual override actuator is no longer being actuated by the operator.

10. The vehicle control system of claim 7 wherein the actuation type detector is configured to obtain the threshold time period based on when the material transfer vehicle comes to a stop between operator actuations of the manual override actuator.

11. A method of controlling a material transfer vehicle, the method comprising:
automatically controlling a propulsion system on the material transfer vehicle to move the material transfer vehicle a commanded distance;
detecting operator actuation of a manual override actuator;
identifying an override distance value based on the detected operator actuation of the manual override actuator; and
automatically controlling the propulsion system to move the material transfer vehicle an override distance indicated by the override distance value.

12. The method of claim 11 and further comprising:
automatically controlling the propulsion system to bring the material transfer vehicle to a stop after moving the override distance.

13. The method of claim 11 and further comprising:
detecting a configuration user input;
displaying, on a display device, a configuration actuator;
detecting user actuation of the configuration actuator indicative of the override distance value; and
storing the override distance value.

14. The method of claim 13 wherein identifying the override distance value comprises:
retrieving the stored override distance value based on detected operator actuation of the manual override actuator.

15. The method of claim 11 wherein identifying the override distance value comprises:
detecting a type of operator actuation of the manual override actuator; and
generating a type signal indicative of the detected type of operator actuation.

16. The method of claim 15 wherein identifying the override distance value comprises:
computing the override distance value based on the type signal; and
generating an override distance value signal indicative of the computed override distance value.

17. The method of claim 16 wherein detecting a type of operator interaction comprises detecting that the type of operator actuation is a multi-actuation type in which the manual override actuator is actuated a multiple (N) times over a threshold time period, and wherein computing the override distance value comprises:
computing the override distance value as N times the override distance.

18. The method of claim 16 wherein detecting a type of operator interaction comprises detecting that the type of operator actuation is a press-and-hold actuation type in which the manual override actuator is continuously actuated over the threshold time period, and wherein computing the override distance value comprises:
computing the override distance value to indicate that the propulsion system is to be automatically controlled to move the material transfer vehicle until the manual override actuator is no longer being actuated by the operator.

19. A vehicle control system, comprising:
a manual override actuator;
at least one processor; and
a datastore storing computer executable instructions which, when executed by the at least one processor, cause the at least one processor to perform steps, comprising:
automatically generating a propulsion control signal to control a propulsion system on a material transfer vehicle to move the material transfer vehicle a commanded distance;
detecting operator actuation of the manual override actuator;
identifying an override distance value based on the detected operator actuation of the manual override actuator; and
automatically generating a control signal to control the propulsion system to move the material transfer vehicle an override distance indicated by the override distance value.

20. The vehicle control system of claim 19 wherein the manual override actuator comprises:
a configurable button displayed on an operator interface display.
